(19) United States
(12) Patent Application Publication
(10) Pub. No.: US 2025/0076794 A1
(43) Pub. Date: Mar. 6, 2025

(54) FIXING APPARATUS AND IMAGE FORMING SYSTEM

(71) Applicant: FUJIFILM Business Innovation Corp., Tokyo (JP)

(72) Inventors: Taisei SEO, Kanagawa (JP); Motoyuki YAGI, Kanagawa (JP); Noriaki KISHI, Kanagawa (JP)

(73) Assignee: FUJIFILM Business Innovation Corp., Tokyo (JP)

(21) Appl. No.: 18/438,002

(22) Filed: Feb. 9, 2024

(30) Foreign Application Priority Data
Aug. 29, 2023 (JP) 2023-139036

(51) Int. Cl. G03G 15/20

(52) U.S. Cl. CPC G03G 15/2032; G03G 15/2028; G03G 15/206; G03G 15/2064; G03G 2215/2009

(57) ABSTRACT

A fixing apparatus includes a heating member that is rotatable, a transport member that transports a recording medium nipped between the heating member and the transport member, a holding member that includes a first pressurizing portion which presses the transport member against the heating member, a notch portion that is provided on an upstream side of the first pressurizing portion of the holding member in a transport direction, that is retracted from the first pressurizing portion to an opposite side of the heating member, and that includes a curved surface having a shape along a peripheral surface of the heating member, and a second pressurizing portion that is attached to the notch portion and that presses the transport member against the heating member with a pressing force weaker than a pressing force of the first pressurizing portion.

### CROSS-REFERENCE TO RELATED APPLICATIONS

This application is based on and claims priority under 35 USC 119 from Japanese Patent Application No. 2023-139036 filed Aug. 29, 2023.

### BACKGROUND

### (i) Technical Field

The present disclosure relates to a fixing apparatus and an image forming system.

### (ii) Related Art

JP2016-057528A discloses a fixing apparatus having a rotatable heating member, an endless belt that travels to follow the rotation of the heating member, a holding member that is provided on an opposite side of the heating member, which is an inside of the endless belt, a first pressurizing member that is provided on an outlet side of the holding member where a recording medium is discharged, and a second pressurizing member that is on an inlet side of the holding member where the recording medium is inserted, that is provided to be inclined with respect to the first pressurizing member along the heating member, and that has a shape along the heating member.

JP2004-286931A discloses a belt fixing apparatus including a fixing belt having an endless sheet shape to be heated, a nip forming member that is fixedly arranged so as to be incapable of rotating on an inside of the fixing belt, and a pressurizing roller that is pressure-welded to the nip forming member with the fixing belt nipped, that has a contact portion with the fixing belt, which becomes a fixing nip, and that is capable of being rotationally driven, in which the fixing belt rotates while sliding on the nip forming member as the pressurizing roller is rotationally driven, and the fixing belt has an elastic layer provided on a base material.

### SUMMARY

Aspects of non-limiting embodiments of the present disclosure relate to a fixing apparatus and an image forming system that can widen the width of a nip portion in a transport direction of a recording medium compared to a case where the recording medium is transported to a nip portion that is formed by two block-shaped pressurizing members which are held by a heating member and a holding member and which are arranged to be separated from each other in a circumferential direction and that has a contact surface which is a flat surface.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing apparatus including a heating member that is rotatable, a transport member that transports a recording medium nipped between the heating member and the transport member, a holding member that includes a first pressurizing portion which presses the transport member against the heating member, a notch portion that is provided on an upstream side of the first pressurizing portion of the holding member in a transport direction, that is retracted from the first pressurizing portion to an opposite side of the heating member, and that includes a curved surface having a shape along a peripheral surface of the heating member, and a second pressurizing portion that is attached to the notch portion and that presses the transport member against the heating member with a pressing force weaker than a pressing force of the first pressurizing portion.

### BRIEF DESCRIPTION OF THE DRAWINGS

Exemplary embodiment(s) of the present invention will be described in detail based on the following figures, wherein:

FIG. 1 is a schematic configuration view showing an image forming system including a fixing apparatus according to a first exemplary embodiment;

FIG. 2 is a sectional view showing the fixing apparatus according to the first exemplary embodiment;

FIG. 3 is a partially enlarged view showing the fixing apparatus according to the first exemplary embodiment;

FIG. 4 is a side view showing a part of a pressurizing unit of the fixing apparatus according to the first exemplary embodiment and is a view showing a holding member including a first pressurizing portion and a second pressurizing portion attached to a notch portion of the holding member;

FIG. 5 is a perspective view showing a part of the pressurizing unit of the fixing apparatus according to the first exemplary embodiment and is a view showing the holding member including the first pressurizing portion and the second pressurizing portion attached to the notch portion of the holding member;

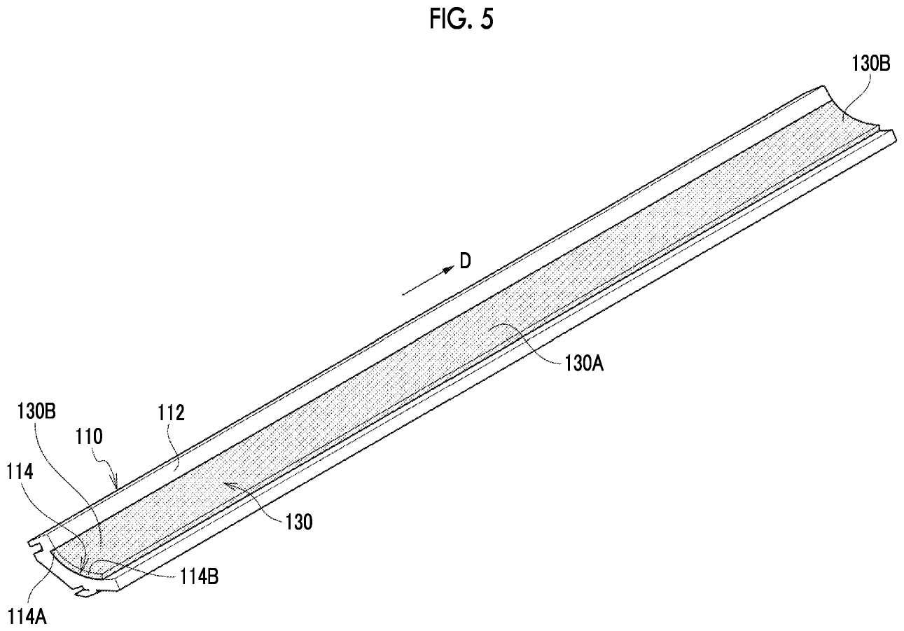

FIG. 6 is a cross-sectional view of the pressurizing unit shown in FIG. 4 taken along line 6A-6A;

FIG. 7 is a cross-sectional view of the pressurizing unit shown in FIG. 4 taken along line 7A-7A;

FIG. 8 is a graph showing a pressing force of the fixing apparatus according to the first exemplary embodiment in a paper passing direction of a recording medium;

FIG. 9 is a cross-sectional view showing a fixing apparatus according to a comparative example; and

FIG. 10 is a graph showing a pressing force of the fixing apparatus according to the comparative example in the paper passing direction of the recording medium.

### DETAILED DESCRIPTION

Hereinafter, an example of an exemplary embodiment according to the present invention will be described based on the drawings. An arrow H shown in each drawing indicates a vertical direction, an arrow W indicates an apparatus width direction, which is a horizontal direction, and an arrow D indicates an apparatus depth direction, which is orthogonal to each of the vertical direction and the horizontal direction.

### First Exemplary Embodiment

Hereinafter, an image forming system according to a first exemplary embodiment will be described.

### Configuration of Image Forming System

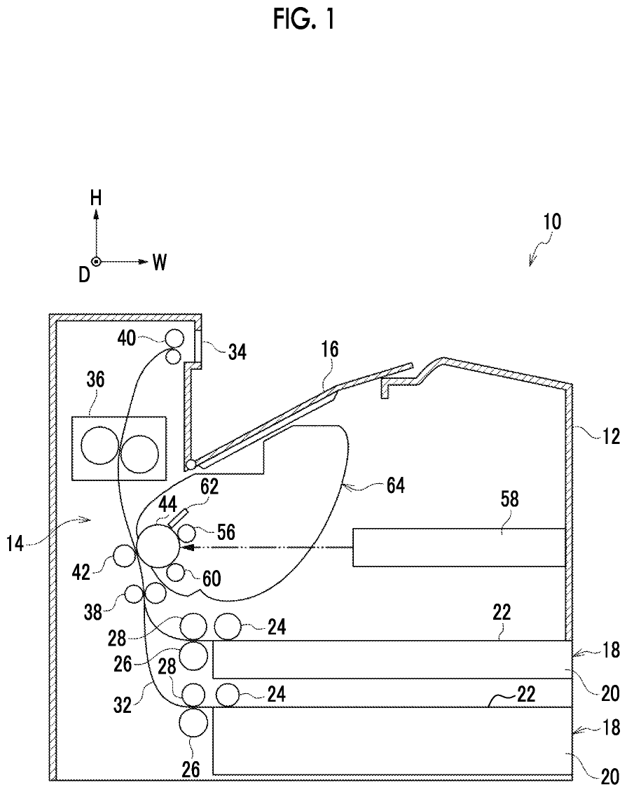

FIG. 1 is a schematic view showing a configuration of an image forming system 10 viewed from a front side. As shown in FIG. 1, the image forming system 10 has an image forming apparatus body 12, and at least one feeding unit 18, an image forming unit 14, and a fixing apparatus 36 are mounted inside the image forming apparatus body 12. In addition, the image forming system 10 includes a discharge port 34 that is arranged in an upper portion of the image forming apparatus body 12 and a transport path 32 in which a recording medium P sent out from the feeding unit 18 is transported to the discharge port 34 through the image forming unit 14 and the fixing apparatus 36. Hereinafter, each configuration will be described.

### Feeding Unit

The feeding unit 18 includes a feeding unit body 20 and a feeding cassette 22 that accommodates the recording medium P. In addition, the feeding unit 18 includes a pickup roll 24 that pulls out the recording medium P placed on the feeding cassette 22 and a feed roll 28 and a retard roll 26 that send out the recording medium P while handling the recording medium P. By the rotation of the pickup roll 24, the feed roll 28, and the retard roll 26, the recording medium P placed on the feeding cassette 22 is transported to a resist roll 38 to be described later along the transport path 32. The feeding cassette 22 is attachably and detachably mounted on the feeding unit body 20. In addition, the number of feeding units may be one, or a plurality of feeding units may be provided, but in the first exemplary embodiment, two feeding units 18 are provided as shown in FIG. 1.

### Image Forming Unit

The image forming unit 14 is an example of an image formation unit and forms a toner image on the recording medium P through an electrophotographic method. For example, the image forming unit 14 includes an image holding body 44 configured by a photoreceptor, a charging device (for example, a charging roll) 56 that uniformly charges the image holding body 44, and an optical writing device 58 that writes a latent image with light on the image holding body 44 charged by the charging device 56. In addition, the image forming unit 14 includes a developing device 60 that has a developing roll which visualizes the latent image on the image holding body 44, which is formed by the optical writing device 58, with a toner, and a transfer device (for example, a transfer roll) 42 that transfers the toner image formed by the developing device 60 to the recording medium P. Further, the image forming unit 14 includes a cleaning device 62 that performs cleaning in order to remove a toner remaining on the image holding body 44.

The optical writing device 58 consists of, for example, a scanning-type laser exposure device, crosses a process cartridge 64 to be described later, and forms a latent image on the image holding body 44. As another example, an LED, a surface-emitting laser, or the like can be used as the optical writing device 58.

The process cartridge 64 is obtained by integrating the image holding body 44, the charging device 56, the developing device 60, and the cleaning device 62 with each other and can be replaced with these devices as a unit. The process cartridge 64 can be taken out from the image forming apparatus body 12 by opening a discharge unit 16.

A toner image on the recording medium P, which is transferred by the transfer device 42, is fixed to the recording medium P by the fixing apparatus 36. A configuration of the fixing apparatus 36 will be described later.

### Transport Path

The transport path 32 is a passage for the recording medium P, which connects the pickup roll 24 of the feeding unit 18 on a lower portion side to the discharge port 34 in the upper portion of the image forming apparatus body 12. The transport path 32 has a portion that is formed along the vertical direction from the pickup roll 24 of the feeding unit 18 on the lower portion side to the fixing apparatus 36 inside the image forming apparatus body 12.

The transfer device 42 and the image holding body 44 are arranged on an upstream side of the fixing apparatus 36 in a transport direction of the recording medium P in the transport path 32, and the resist roll 38 is arranged on the upstream side of the transfer device 42 and the image holding body 44. Further, a discharge roll 40 is arranged in the vicinity of the discharge port 34 in the transport path 32.

### Operation of Image Forming System

Herein, an operation of the image forming system 10 will be described. The recording medium P sent out by the pickup roll 24 from the feeding cassette 22 of the feeding unit 18 is introduced into the transport path 32, is handled by the retard roll 26 and the feed roll 28 so as to be introduced into the transport path 32, and is temporarily stopped by the resist roll 38. Then, as the recording medium P is transported between the transfer device 42 and the image holding body 44 at the right timing by the resist roll 38, a toner image is transferred from the image holding body 44 to the recording medium P, and the transferred toner image is fixed by the fixing apparatus 36. Further, the recording medium P to which the toner image is fixed is discharged from the discharge port 34 to the discharge unit 16 by the discharge roll 40.

### Configuration of Fixing Apparatus

Next, the fixing apparatus 36 according to the first exemplary embodiment, which is included in the image forming system 10, will be described.

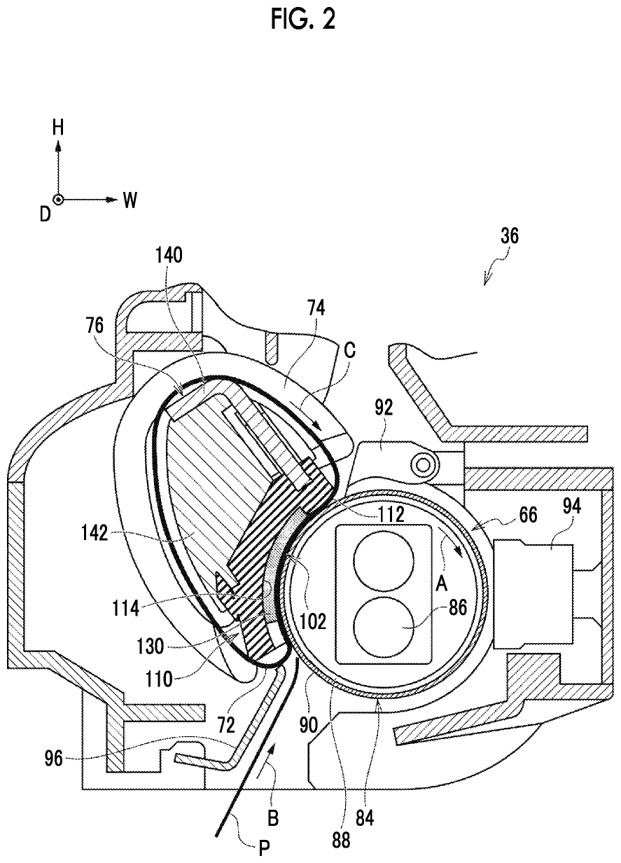

As shown in FIG. 2, the fixing apparatus 36 includes a heating roll 66 that is an example of a heating member, an endless belt 72 that is formed in an endless belt shape, and a guide member 74 that rotatably guides the endless belt 72. The endless belt 72 is an example of a transport member. In addition, the fixing apparatus 36 includes a pressurizing unit 76 that is arranged inside the endless belt 72 and that presses the endless belt 72 against the heating roll 66. The fixing apparatus 36 has a configuration adopting a Free Belt Nip Fuser (FBNF) method in which the pressurizing unit 76 is provided with a first pressurizing portion 112 and a second pressurizing portion 130 each of which has different hardness as will be described later. The fixing apparatus 36 may include an impregnation pad (not shown) that supplies a lubricant to an inside of the endless belt 72.

### Guide Member

The guide member 74 is arranged at both ends of the endless belt 72 and the pressurizing unit 76, and the pressurizing unit 76 is supported by the guide member 74. A sliding sheet (not shown) for reducing a friction between the endless belt 72 and the pressurizing unit 76 may be provided between the endless belt 72 and the pressurizing unit 76.

### Heating Roll

The heating roll 66 has a cylindrical roll portion 84 and a heater 86 arranged in the roll portion 84. The roll portion 84 is rotatably supported by a heating roll bearing (not shown) and rotates in an arrow A direction. In addition, the roll portion 84 includes a core 88 that consists of, for example, a metal material such as iron, stainless steel, and aluminum and a release layer 90 that is coated on or applied to the core 88. For example, the roll portion 84 is a so-called hard roll that does not have an elastic layer. The core 88 has an outer diameter of, for example, 25 mm and a wall thickness of, for example, 0.7 mm. The release layer 90 is formed of a material excellent in insulation and releasability, for example, a fluororesin such as perfluoroalkoxyalkane (PFA) and has a film thickness of, for example, 20 m.

For example, a plurality of (for example, five) peeling claws 92 are in contact with the roll portion 84. The heater 86 is configured by, for example, two lamps. In addition, for example, on an opposite side of the heating roll 66 to the endless belt 72, a thermostat 94 is provided to face the heating roll 66.

### Endless Belt

The endless belt 72 is provided between the heating roll 66 and the pressurizing unit 76 and follows the rotation of the heating roll 66 to travel in an arrow C direction. The endless belt 72 transports the recording medium P nipped between the heating roll 66 and the endless belt 72. As the heating roll 66 and the endless belt 72 come into contact with each other in a state of being pressurized by the pressurizing unit 76, a nip portion 102 is formed, and a toner image is fixed to the recording medium P by the nip portion 102. The endless belt 72 is formed of, for example, a synthetic resin such as a polyimide and in an endless belt shape having a wall thickness of, for example, 75 m. Although not shown, a release layer formed of, for example, a fluororesin such as perfluoroalkoxyalkane (PFA) is provided on the surface of the endless belt 72.

An introduction side guide portion 96 is provided on the upstream side of the nip portion 102. The recording medium P transported in an arrow B direction is guided to the introduction side guide portion 96, and a leading end of the recording medium P is introduced into the nip portion 102. In addition, although not shown, a discharge side guide portion that guides the recording medium P is provided on a downstream side of the nip portion 102.

### Pressurizing Unit

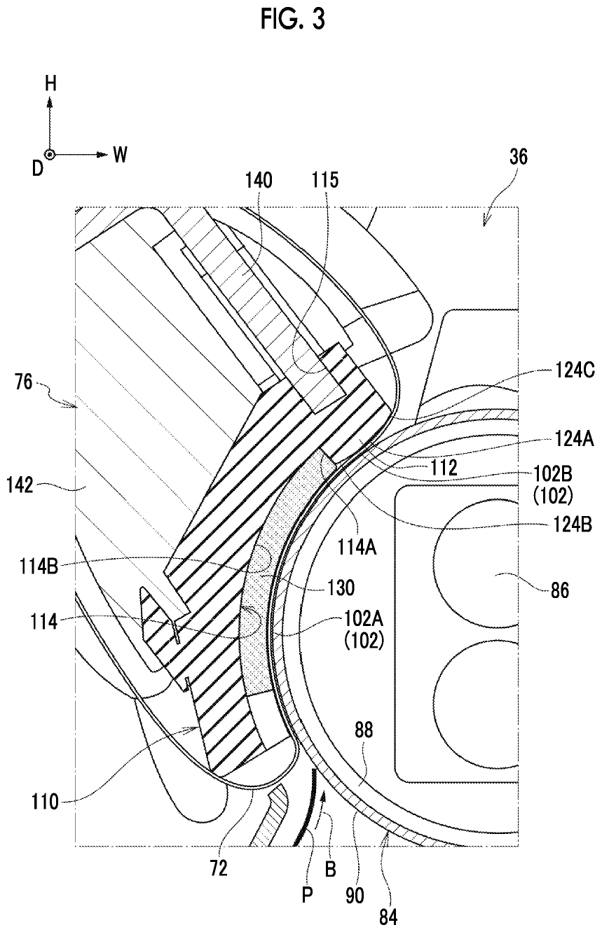

As shown in FIGS. 2 and 3, the pressurizing unit 76 includes a holding member 110 that includes the first pressurizing portion 112, a notch portion 114 that is provided on the upstream side of the first pressurizing portion 112 of the holding member 110 in the transport direction, and the second pressurizing portion 130 that is attached to the notch portion 114. In addition, the pressurizing unit 76 has a pressing member 140 that presses the first pressurizing portion 112 of the holding member 110 to a heating roll 66 side and a housing 142 that supports the pressing member 140.

The pressing member 140 is supported such that the first pressurizing portion 112 of the holding member 110 and the second pressurizing portion 130 attached to the notch portion 114 of the holding member 110 are pressed to the heating roll 66 side. Accordingly, as the first pressurizing portion 112 and the second pressurizing portion 130 are pressed against the heating roll 66 via the endless belt 72, the nip portion 102 where the endless belt 72 and the heating roll 66 come into contact with each other is formed. Each configuration of the pressurizing unit 76 will be described below.

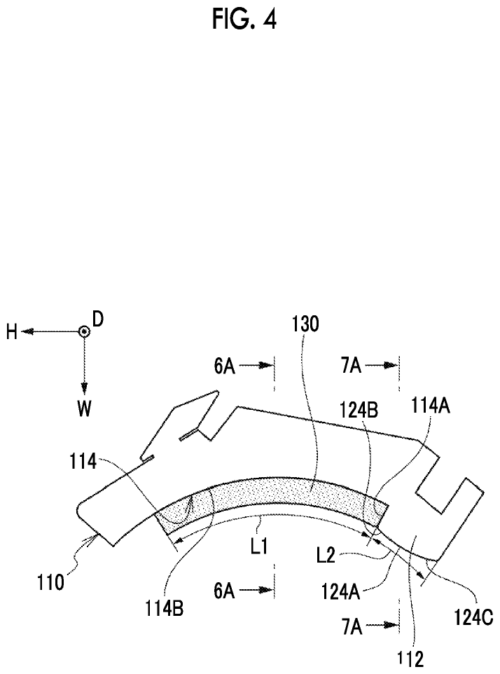

As shown in FIGS. 3 and 4, the holding member 110 has, as described above, the first pressurizing portion 112 and the notch portion 114 that is on the upstream side of the first pressurizing portion 112 in the transport direction and that is retracted from the first pressurizing portion 112 to the opposite side of the heating roll 66. The notch portion 114 includes a wall portion 114A that is retracted from the first pressurizing portion 112 in an intersecting direction and a curved surface 114B that is formed in a shape extending from a rear end portion of the wall portion 114A along a peripheral surface of the heating roll 66.

For example, the holding member 110 has a length equivalent to the length of the heating roll 66 in an axial direction. The holding member 110 (that is, the first pressurizing portion 112) is formed of, for example, a heat-resistant resin such as polyethylene terephthalate (PET) containing glass. For example, the first pressurizing portion 112 is formed of a resin harder than the hardness of the second pressurizing portion 130. That is, the hardness of the first pressurizing portion 112 is higher than the hardness of the second pressurizing portion 130, and the second pressurizing portion 130 is softer than the first pressurizing portion 112.

For example, the Asker C hardness of the first pressurizing portion 112 is 70 degrees or more and 75 degrees or less, and the Asker C hardness of the second pressurizing portion 130 is 30 degrees or more and 35 degrees or less. Asker C hardness is acquired as follows.

Eighty places at equal intervals in a surface of a surface layer are measured with a DE FACT STANDARD ASKER C-TYPE HARDNESS TESTER manufactured by Kobunshi Keiki Co., Ltd., and an average value thereof is defined as the Asker C hardness of the surface layer. The measurement is performed under an environment of a temperature of 23° C. and humidity of 55% RH.

The second pressurizing portion 130 is attached to at least the curved surface 114B of the notch portion 114 in a state of being in contact with the wall portion 114A of the notch portion 114 (see FIG. 4). For example, the second pressurizing portion 130 is attached to the curved surface 114B with an adhesive or the like. In this case, the second pressurizing portion 130 may be fixed to the wall portion 114A with an adhesive or the like. As the second pressurizing portion 130 is attached to the notch portion 114 in a state of being in contact with the wall portion 114A, the second pressurizing portion 130 and the first pressurizing portion 112 are arranged continuously along the transport direction (arrow B direction) of the recording medium P. That is, a gap between the second pressurizing portion 130 and the first pressurizing portion 112 is not formed, and the second pressurizing portion 130 and the first pressurizing portion 112 are arranged not to be separated from each other.

The second pressurizing portion 130 presses the endless belt 72 against the heating roll 66 with a pressing force weaker than a pressing force of the first pressurizing portion 112. For example, the second pressurizing portion 130 has a length equivalent to the length of the holding member 110 in a longitudinal direction. The second pressurizing portion 130 is formed of, for example, a heat-resistant foamed resin such as a silicone sponge.

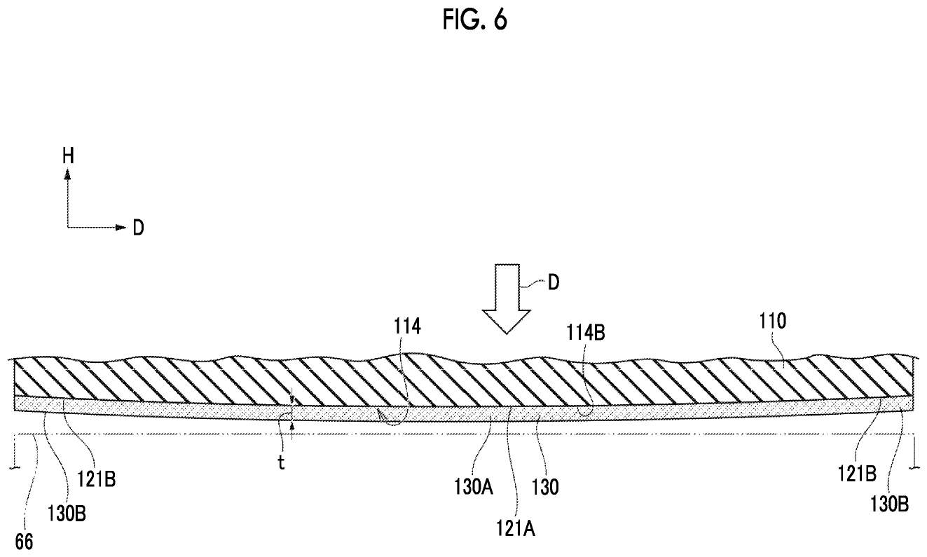

As shown in FIG. 6, in a state of being attached to the curved surface 114B of the notch portion 114, the second pressurizing portion 130 is in a shape in which a central portion 130A of the second pressurizing portion 130 in the axial direction is convexly curved toward the heating roll 66 more than end portions 130B on both sides in the axial direction are. In FIG. 6, in order to make the configuration easy to understand, the heating roll 66 is shown by an imaginary line before pressing the second pressurizing portion 130 against the heating roll 66 in an arrow D direction. In addition, in FIG. 6, the second pressurizing portion 130 is shown in an exaggerated shape rather than the actual shape such that the convexly curved shape of the second pressurizing portion 130 is well seen.

For example, a thickness t of the second pressurizing portion 130 in a direction intersecting the curved surface 114B is constant along the axial direction, and the curved surface 114B is in a shape in which a central portion 121A in the axial direction is convexly curved toward the heating roll 66 more than end portions 121B on both sides in the axial direction are. Variations in the thickness t of the second pressurizing portion 130 in the direction intersecting the curved surface 114B are, for example, preferably 5% or less. Accordingly, the second pressurizing portion 130 attached to the curved surface 114B is formed such that the central portion 130A in the axial direction is curved in a convex shape toward the heating roll 66 more than the end portions 130B on both sides in the axial direction are.

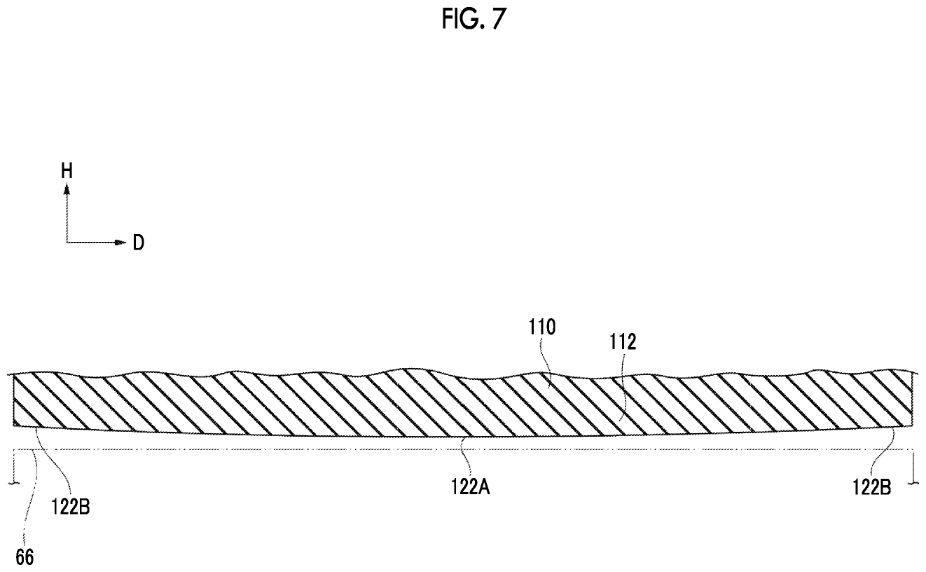

As shown in FIG. 7, the first pressurizing portion 112 is in a shape in which a central portion 122A in the axial direction protrudes toward the heating roll 66 more than end portions 122B on both sides in the axial direction do. In FIG. 7, in order to make the configuration easy to understand, the heating roll 66 is shown by an imaginary line before pressing the first pressurizing portion 112 against the heating roll 66 in the arrow D direction. In addition, in FIG. 7, the central portion of the first pressurizing portion 112 is shown in an exaggerated shape rather than the actual shape such that the protruding shape of the central portion of the first pressurizing portion 112 is well seen.

As shown in FIGS. 3 and 4, a central portion 124A of the first pressurizing portion 112 in the transport direction (arrow B direction) of the recording medium P protrudes toward the heating roll 66 more than an upstream side end portion 124B and a downstream side end portion 124C in the transport direction of the recording medium P do. That is, the central portion 124A of the first pressurizing portion 112 along the transport direction (arrow B direction) of the recording medium P is in a convexly curved shape.

A length L1 of the second pressurizing portion 130 along the transport direction of the recording medium P is longer than a length L2 of the first pressurizing portion 112 along the transport direction of the recording medium P (see FIG. 4). The length L1 of the second pressurizing portion 130 along the transport direction of the recording medium P is, for example, preferably at least two times and no more than eight times the length L2 of the first pressurizing portion 112 along the transport direction of the recording medium P. For example, the length L1 of the second pressurizing portion 130 along the transport direction of the recording medium P is set to approximately 3.5 times the length L2 of the first pressurizing portion 112 along the transport direction of the recording medium P.

The pressing member 140 supports the holding member 110 and presses the holding member 110 to the heating roll 66 side as both ends of the pressing member 140 are supported by the guide member 74. In this case, an end portion of the pressing member 140 in the longitudinal direction (that is, the apparatus depth direction) penetrates the guide member 74, and the end portion of the pressing member 140 in the longitudinal direction is biased to the heating roll 66 side by a biasing unit (not shown) such as a spring.

The pressing member 140 is made of, for example, a metal. For example, the pressing member 140 is an L-shaped member, and one end thereof in the longitudinal direction is inserted into a concave portion 115 (see FIG. 3) formed on the inside of the first pressurizing portion 112 of the holding member 110. The pressing member 140 is arranged such that the longitudinal direction thereof is in a direction intersecting the surface of the first pressurizing portion 112.

The housing 142 is formed of, for example, a synthetic resin such as polytetrafluoroethylene (PET) containing glass and supports the holding member 110, the pressing member 140, and the endless belt 72.

### Action of First Exemplary Embodiment

Next, actions of the first exemplary embodiment will be described.

In the fixing apparatus 36 of the image forming system 10, the recording medium P to which a toner image is transferred by the image forming unit 14 passes through the transport path 32 and is sent into the nip portion 102 where the endless belt 72 and the heating roll 66 are pressurized and brought into contact with each other by the pressurizing unit 76. The pressurizing unit 76 includes the first pressurizing portion 112 of the holding member 110 and the second pressurizing portion 130 attached to the notch portion 114 of the holding member 110. In addition, as the endless belt 72 is pressed against the heating roll 66 by the first pressurizing portion 112 and the second pressurizing portion 130, the nip portion 102 is formed.

In this case, as the heating roll 66 is rotationally driven and the endless belt 72 follows the heating roll 66 and also moves to go around the outer periphery of the pressurizing unit 76, the recording medium P is sent into the nip portion 102. A leading end of the sent recording medium P is nipped between the heating roll 66 and the endless belt 72. First, as the sent recording medium P is pressed against the heating roll 66 and the second pressurizing portion 130 and then is pressed against the heating roll 66 and the first pressurizing portion 112, a toner image is fixed to the recording medium P. The second pressurizing portion 130 presses the endless belt 72 against the heating roll 66 with a pressing force weaker than a pressing force of the first pressurizing portion 112.

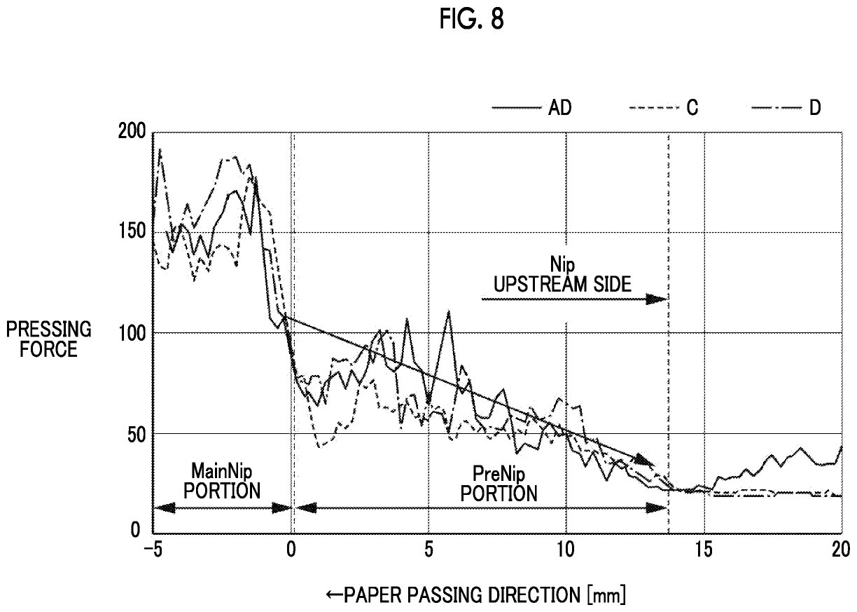

FIG. 8 shows a pressing force (that is, a pressure distribution) of the nip portion 102 with respect to a paper passing direction (that is, the transport direction) of the recording medium P between the endless belt 72 and the heating roll 66. As shown in FIG. 8, the nip portion 102 of the heating roll 66 and the endless belt 72 includes a pre-nip portion 102A formed by the second pressurizing portion 130 on the upstream side (that is, an inlet side) in the transport direction of the recording medium P and a main nip portion 102B formed by the first pressurizing portion 112 on the downstream side (that is, an outlet side) in the transport direction of the recording medium P (see FIG. 3). First, in the pre-nip portion 102A on the upstream side (that is, the inlet side) in the transport direction of the recording medium P, the recording medium P is pressed by the second pressurizing portion 130 to the heating roll 66 side with a pressing force weaker than a pressing force of the first pressurizing portion 112. After then, in the main nip portion 102B on the downstream side (that is, the outlet side) in the transport direction of the recording medium P, the recording medium P is pressed by the first pressurizing portion 112 to the heating roll 66 side with a pressing force stronger than a pressing force of the second pressurizing portion 130.

In addition, in a case of using the heating roll 66 that does not have an elastic layer, it is necessary to widen the width of the nip portion 102 in the transport direction of the recording medium P in order to obtain a sufficient pressing force in the nip portion 102. In the first exemplary embodiment, the notch portion 114 of the holding member 110 includes the curved surface 114B that is retracted from the first pressurizing portion 112 to the opposite side of the heating roll 66 and that has a shape along the peripheral surface of the heating roll 66, and the second pressurizing portion 130 is attached to the curved surface 114B of the notch portion 114. For this reason, in the graph shown in FIG. 8, the width (a width in the transport direction of the recording medium P) of the nip portion 102 formed by the first pressurizing portion 112 and the second pressurizing portion 130 widens. As the width (the width in the transport direction of the recording medium P) of the nip portion 102 formed by the first pressurizing portion 112 and the second pressurizing portion 130 widens, a fixing temperature of the heating roll 66 may be lowered. For example, the length of the nip portion 102 in the transport direction of the recording medium P is approximately 14 mm. In addition, for example, a fixing temperature in the nip portion 102 of the heating roll 66 and the endless belt 72 is 104° C.

As described above, in the fixing apparatus 36, the second pressurizing portion 130 is attached to the notch portion 114 including the curved surface 114B that is retracted from the first pressurizing portion 112 of the holding member 110 to the opposite side of the heating roll 66 and that has a shape along the peripheral surface of the heating roll 66. For this reason, in the fixing apparatus 36, the width of the nip portion 102 in the transport direction of the recording medium P may be widened compared to a case where the recording medium P is transported to a nip portion that is formed by two block-shaped pressurizing members which are held by the heating roll and the holding member and which are arranged to be separated from each other in a circumferential direction and that has a contact surface which is a flat surface.

In addition, as the second pressurizing portion 130 is attached to the notch portion 114 including the curved surface 114B that is retracted from the first pressurizing portion 112 of the holding member 110 and that has a shape along the peripheral surface of the heating roll 66, so-called sagging that is a reduction in elastic forces of the first pressurizing portion 112 and the second pressurizing portion 130 is unlikely to occur even in a case where the fixing apparatus 36 is used over time. For this reason, in the graph shown in FIG. 8, a pressure valley in which a pressing force between the first pressurizing portion 112 and the second pressurizing portion 130 weakens is unlikely to be caused.

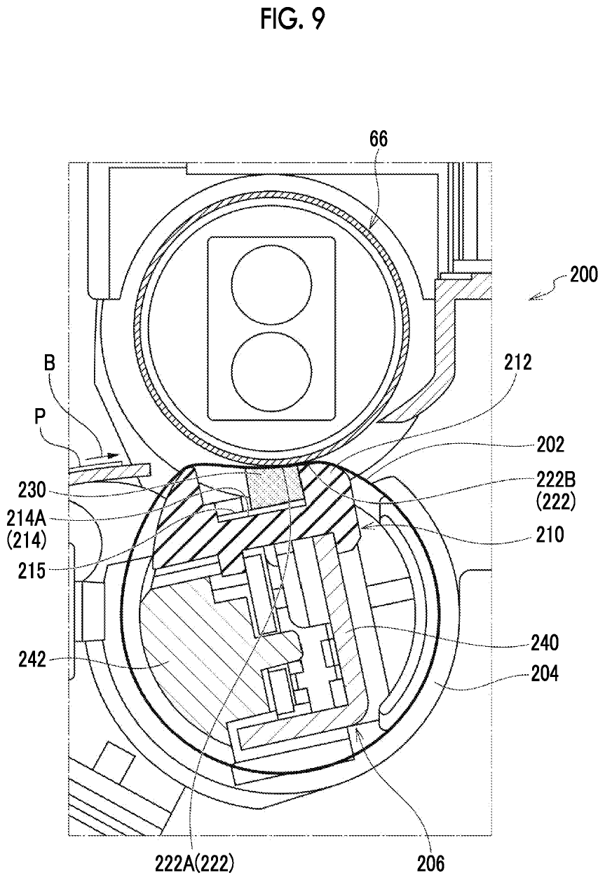

FIG. 9 shows a fixing apparatus 200 of a comparative example. As shown in FIG. 9, the fixing apparatus 200 of the comparative example includes an endless belt 202, a guide member 204, and a pressurizing unit 206 arranged inside the endless belt 202. In the fixing apparatus 200, the recording medium P is transported in the transport direction (arrow B direction) along the horizontal direction and is sent into a nip portion 222 where the endless belt 202 and the heating roll 66 come into contact with each other.

The pressurizing unit 206 includes a holding member 210 that includes a first pressurizing portion 212, a notch portion 214 that is provided on the upstream side of the first pressurizing portion 212 of the holding member 210 in the transport direction, and a second pressurizing portion 230 that is attached to the notch portion 214 via a plate material 215. In addition, the pressurizing unit 206 has a pressing member 240 that presses the holding member 210 against the heating roll 66 via the endless belt 202 and a housing 242 that supports the pressing member 240. The notch portion 214 includes a contact surface 214A that has a flat surface shape recessed to the opposite side of the heating roll 66, and the second pressurizing portion 230 is attached via the flat-surface shaped plate material 215 arranged on the contact surface 214A. The contact surface 214A extends in a direction intersecting the axial direction of the heating roll 66 in a state of being viewed from a direction along the axial direction of the heating roll 66.

The holding member 210 including the first pressurizing portion 212 is formed of a resin (for example, polytetrafluoroethylene or the like) harder than the second pressurizing portion 230. The second pressurizing portion 230 is formed of a foamed resin (for example, silicone sponge or the like).

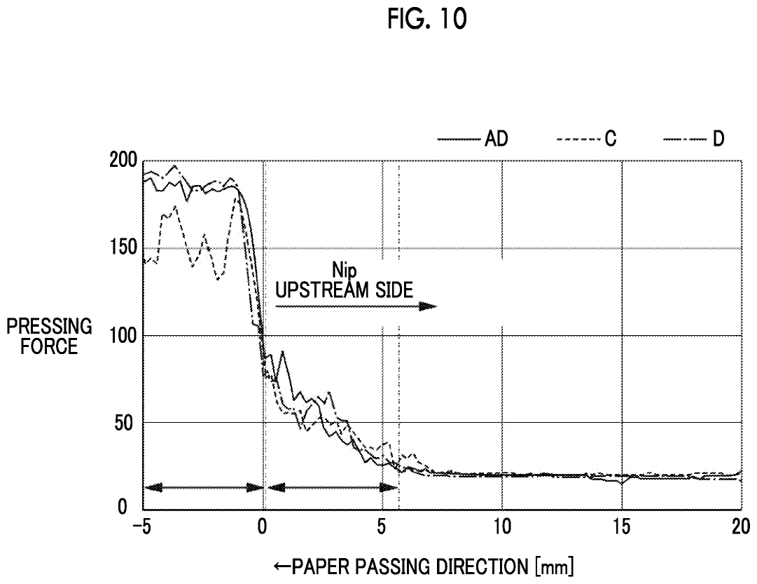

As shown in FIGS. 9 and 10, the nip portion 222 of the heating roll 66 and the endless belt 202 includes a pre-nip portion 222A formed by the second pressurizing portion 230 on the upstream side (that is, the inlet side) in the transport direction of the recording medium P and a main nip portion 222B formed by the first pressurizing portion 212 on the downstream side (that is, the outlet side) in the transport direction of the recording medium P. First, in the pre-nip portion 222A on the upstream side (that is, the inlet side) in the transport direction of the recording medium P, the recording medium P is pressed by the second pressurizing portion 230 to the heating roll 66 side with a pressing force weaker than a pressing force of the first pressurizing portion 212. After then, in the main nip portion 222B on the downstream side (that is, the outlet side) in the transport direction of the recording medium P, the recording medium P is pressed by the first pressurizing portion 212 to the heating roll 66 side with a pressing force stronger than a pressing force of the second pressurizing portion 230.

In the fixing apparatus 200 of the comparative example, the notch portion 214 of the holding member 210 includes the contact surface 214A that has a flat surface shape, and the second pressurizing portion 230 is attached via the flat-surface shaped plate material 215 arranged on the contact surface 214A. For this reason, the length of the pre-nip portion 222A formed by the second pressurizing portion 230 along the transport direction of the recording medium P is shorter than the length of the pre-nip portion 102A formed by the second pressurizing portion 130 attached to the notch portion 114 of the holding member 110 along the transport direction of the recording medium P as in the first exemplary embodiment (see FIGS. 9 and 10). For example, the length of the nip portion 222, which is the sum of the pre-nip portion 102A and the main nip portion 222B, in the transport direction of the recording medium P is approximately 6 mm. In addition, as the length of the nip portion 222 in the transport direction of the recording medium P is short, a fixing temperature for fixing a toner image on the recording medium P increases. For example, a fixing temperature in the nip portion 222 of the heating roll 66 and the endless belt 202 is 125° C.

On the contrary, in the fixing apparatus 36 of the first exemplary embodiment, the notch portion 114 of the holding member 110 includes the curved surface 114B having a shape along the peripheral surface of the heating roll 66. For this reason, the length of the second pressurizing portion 130 attached to the notch portion 114 along the transport direction of the recording medium P can be made longer than the length of the second pressurizing portion 230 attached to the flat-surface shaped contact surface 214A of the notch portion 214 of the fixing apparatus 200 of the comparative example via the plate material 215 along the transport direction of the recording medium P.

In addition, in the fixing apparatus 36, the first pressurizing portion 112 is formed of a resin harder than the hardness of the second pressurizing portion 130. For this reason, compared to a case where the first pressurizing portion and the second pressurizing portion are formed of a resin having the same hardness, in the fixing apparatus 36, the second pressurizing portion 130 is capable of pressing the endless belt 72 against the heating roll 66 with a pressing force weaker than a pressing force of the first pressurizing portion 112 with a simple configuration.

In addition, in the fixing apparatus 36, the second pressurizing portion 130 is formed of a foamed resin. For this reason, compared to a case where the second pressurizing portion is formed of an unfoamed resin, in the fixing apparatus 36, the second pressurizing portion 130 is capable of pressing the endless belt 72 against the heating roll 66 with a pressing force weaker than a pressing force of the first pressurizing portion 112 with a simple configuration.

In addition, in the fixing apparatus 36, in a state of being attached to the curved surface 114B of the notch portion 114, the second pressurizing portion 130 is in a shape in which the central portion 130A in the axial direction is convexly curved toward the heating roll 66 more than the end portions 130B on both sides in the axial direction are (see FIG. 6). For this reason, compared to a case where the second pressurizing portion has a uniform shape in the axial direction in a state of being held by the curved surface of the notch portion, in the fixing apparatus 36, a decrease in the pressing force of the second pressurizing portion 130 is suppressed by the central portion 130A in the axial direction.

In addition, in the fixing apparatus 36, the thickness of the second pressurizing portion 130 in the direction intersecting the curved surface 114B is constant along the axial direction, and the curved surface 114B is in a shape in which the central portion 121A in the axial direction is convexly curved toward the heating roll 66 more than the end portions 121B on both sides in the axial direction are (see FIG. 6). For this reason, compared to a case where the second pressurizing portion is formed such that the central portion in the axial direction is formed to be thicker than both end portions in the axial direction, the fixing apparatus 36 is easy to manufacture.

In addition, in the fixing apparatus 36, the first pressurizing portion 112 is in a shape in which the central portion 124A in the transport direction of the recording medium P protrudes toward the heating roll 66 more than the upstream side end portion 124B and the downstream side end portion 124C in the transport direction of the recording medium P do (see FIG. 3). Further, the first pressurizing portion 112 is in a shape in which the central portion 122A in the axial direction protrudes toward the heating roll 66 more than the end portions 122B on both sides in the axial direction do (see FIG. 7). For this reason, compared to a case where the first pressurizing portion has a uniform shape in the transport direction of the recording medium and the axial direction, in the fixing apparatus 36, a decrease in the pressing force of the first pressurizing portion 112 is suppressed by the central portion 124A in the axial direction.

In addition, in the fixing apparatus 36, the length L1 of the second pressurizing portion 130 along the transport direction of the recording medium P is longer than the length L2 of the first pressurizing portion 112 along the transport direction of the recording medium P (see FIG. 4). For this reason, compared to a case where the lengths of the second pressurizing portion and the first pressurizing portion along the transport direction of the recording medium are the same, in the fixing apparatus 36, the length of the nip portion 102 between the endless belt 72 and the heating roll 66 is easily secured.

In addition, in the fixing apparatus 36, the length L1 of the second pressurizing portion 130 along the transport direction of the recording medium P is at least two times and no more than eight times the length L2 of the first pressurizing portion 112 along the transport direction of the recording medium P. For this reason, compared to a case where the length of the second pressurizing portion along the transport direction of the recording medium is shorter than two times the length of the first pressurizing portion along the transport direction of the recording medium, in the fixing apparatus 36, the length of the nip portion 102 between the endless belt 72 and the heating roll 66 is easily secured. In addition, compared to a case where the length of the second pressurizing portion along the transport direction of the recording medium is longer than eight times the length of the first pressurizing portion along the transport direction of the recording medium, a fixing performance of a toner image on the recording medium P is easily maintained.

In addition, in the fixing apparatus 36, the pressing member 140 that is made of a metal and that presses the first pressurizing portion 112 of the holding member 110 against the heating roll 66 via the endless belt 72 is provided. For this reason, compared to a case where a notch portion side of the holding member is pressed against the heating roll via the endless belt, in the fixing apparatus 36, the first pressurizing portion 112 is easily configured to press the endless belt 72 against the heating roll 66 with a pressing force stronger than a pressing force of the second pressurizing portion 130.

In addition, in the fixing apparatus 36, the notch portion 114 includes the wall portion 114A that is retracted from the first pressurizing portion 112 in the intersecting direction, and the second pressurizing portion 130 is attached to the notch portion 114 in a state of being in contact with the wall portion 114A. For this reason, compared to a case where the wall portion that is retracted from the first pressurizing portion and the second pressurizing portion are arranged to be separated from each other, in the fixing apparatus 36, the width of the nip portion 102, which is formed by the first pressurizing portion 112, the second pressurizing portion 130, and the heating roll 66, in the transport direction of the recording medium P may be widened.

In addition, the image forming system 10 including the fixing apparatus 36 has the image forming unit 14 that forms a toner image on the recording medium P and the fixing apparatus 36 that fixes the toner image on the recording medium P. The width of the nip portion 102, which is formed by the first pressurizing portion 112, the second pressurizing portion 130, and the heating roll 66, in the transport direction of the recording medium P is easily secured by the fixing apparatus 36. For this reason, compared to a case where the recording medium is transported to a nip portion that is formed by two block-shaped pressurizing members which are held by the heating roll and the holding member and which are arranged to be separated from each other in the circumferential direction and that has a contact surface which is a flat surface, in the image forming system 10, a fixing temperature may be lowered.

### Supplementary Description

Although the endless belt 72 is included in the first exemplary embodiment, the present disclosure is not limited to the configuration, and it is possible to be changed into other configurations insofar as the recording medium P can be transported.

Although the second pressurizing portion 130 is formed of a foamed resin in the first exemplary embodiment, the present disclosure is not limited to the configuration. For example, the second pressurizing portion may be formed of a resin other than the foamed resin insofar as the second pressurizing portion is a member having hardness softer than the hardness of the first pressurizing portion.

In the first exemplary embodiment, a ratio between the length of the first pressurizing portion 112 along the transport direction of the recording medium P and the length of the second pressurizing portion 130 along the transport direction of the recording medium P can be changed. In addition, a member configuring the pressurizing unit 76 is not limited to the present disclosure and can be changed as appropriate.

Although details of a certain exemplary embodiment of the present invention have been described, the present invention is not limited to such an exemplary embodiment, and it is clear for a person skilled in the art that adopting other various exemplary embodiments within the scope of the present invention is possible.

### Supplementary Note

Hereinafter, aspects of the present disclosure will be additionally described.

(((1)))

A fixing apparatus comprising:
a heating member that is rotatable;
a transport member that transports a recording medium nipped between the heating member and the transport member;
a holding member that includes a first pressurizing portion which presses the transport member against the heating member;
a notch portion that is provided on an upstream side of the first pressurizing portion of the holding member in a transport direction, that is retracted from the first pressurizing portion to an opposite side of the heating member, and that includes a curved surface having a shape along a peripheral surface of the heating member; and
a second pressurizing portion that is attached to the notch portion and that presses the transport member against the heating member with a pressing force weaker than a pressing force of the first pressurizing portion.
   (((2)))

The fixing apparatus according to (((1))),
wherein the first pressurizing portion is formed of a resin harder than hardness of the second pressurizing portion.
   (((3)))

The fixing apparatus according to (((1))) or (((2))),
wherein the second pressurizing portion is formed of a foamed resin.
   (((4)))

The fixing apparatus according to any one of (((1))) to (((3))),
wherein in a state of being attached to the curved surface of the notch portion, the second pressurizing portion is in a shape in which a central portion in an axial direction is convexly curved toward the heating member more than both end portions in the axial direction are.
   (((5)))

The fixing apparatus according to (((4))),
wherein a thickness of the second pressurizing portion in a direction intersecting the curved surface is constant along the axial direction, and
the curved surface is in a shape in which a central portion in the axial direction is convexly curved toward the heating member more than both end portions in the axial direction are.
   (((6)))

The fixing apparatus according to any one of (((1))) to (((5))),
wherein the first pressurizing portion is in a shape in which a central portion in the transport direction of the recording medium protrudes toward the heating member more than a downstream side and an upstream side in the transport direction of the recording medium do, and the central portion in the axial direction protrudes toward the heating member more than both end portions in the axial direction do.
   (((7)))

The fixing apparatus according to any one of (((1))) to (((6))),
wherein a length of the second pressurizing portion along the transport direction of the recording medium is longer than a length of the first pressurizing portion along the transport direction of the recording medium.
   (((8)))

The fixing apparatus according to (((7))),
wherein the length of the second pressurizing portion along the transport direction of the recording medium is at least two times and no more than eight times the length of the first pressurizing portion along the transport direction of the recording medium.
   (((9)))

The fixing apparatus according to any one of (((1))) to (((8))), further comprising:
a pressing member that is made of a metal and that presses the first pressurizing portion of the holding member against the heating member via the transport member.
   (((10)))

The fixing apparatus according to any one of (((1))) to (((9))),
wherein the notch portion includes a wall portion that is retracted from the first pressurizing portion in an intersecting direction, and
the second pressurizing portion is attached to the notch portion in a state of being in contact with the wall portion.
   (((11)))

An image forming system comprising:
an image formation unit that forms a toner image on a recording medium; and
the fixing apparatus according to any one of (((1))) to (((10))) that fixes the toner image to the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing apparatus comprising:
a heating member that is rotatable;
a transport member that transports a recording medium nipped between the heating member and the transport member;
a holding member that includes a first pressurizing portion which presses the transport member against the heating member;
a notch portion that is provided on an upstream side of the first pressurizing portion of the holding member in a transport direction, that is retracted from the first pressurizing portion to an opposite side of the heating member, and that includes a curved surface having a shape along a peripheral surface of the heating member; and
a second pressurizing portion that is attached to the notch portion and that presses the transport member against the heating member with a pressing force weaker than a pressing force of the first pressurizing portion.

2. The fixing apparatus according to claim 1,
wherein the first pressurizing portion is formed of a resin harder than hardness of the second pressurizing portion.

3. The fixing apparatus according to claim 2,
wherein the second pressurizing portion is formed of a foamed resin.

4. The fixing apparatus according to claim 1,
wherein in a state of being attached to the curved surface of the notch portion, the second pressurizing portion is in a shape in which a central portion in an axial direction is convexly curved toward the heating member more than both end portions in the axial direction are.

5. The fixing apparatus according to claim 4,
wherein a thickness of the second pressurizing portion in a direction intersecting the curved surface is constant along the axial direction, and
the curved surface is in a shape in which a central portion in the axial direction is convexly curved toward the heating member more than both end portions in the axial direction are.

6. The fixing apparatus according to claim 4,
wherein the first pressurizing portion is in a shape in which a central portion in the transport direction of the recording medium protrudes toward the heating member more than a downstream side and an upstream side in the transport direction of the recording medium do, and the central portion in the axial direction protrudes toward the heating member more than both end portions in the axial direction do.

7. The fixing apparatus according to claim 1,
wherein a length of the second pressurizing portion along the transport direction of the recording medium is longer than a length of the first pressurizing portion along the transport direction of the recording medium.

8. The fixing apparatus according to claim 7,
wherein the length of the second pressurizing portion along the transport direction of the recording medium is at least two times and no more than eight times the length of the first pressurizing portion along the transport direction of the recording medium.

9. The fixing apparatus according to claim 1, further comprising:
a pressing member that is made of a metal and that presses the first pressurizing portion of the holding member against the heating member via the transport member.

10. The fixing apparatus according to claim 1,
wherein the notch portion includes a wall portion that is retracted from the first pressurizing portion in an intersecting direction, and
the second pressurizing portion is attached to the notch portion in a state of being in contact with the wall portion.

11. An image forming system comprising:
an image formation unit that forms a toner image on a recording medium; and
the fixing apparatus according to claim 1 that fixes the toner image to the recording medium.

12. An image forming system comprising:
an image formation unit that forms a toner image on a recording medium; and
the fixing apparatus according to claim 2 that fixes the toner image to the recording medium.

13. An image forming system comprising:
an image formation unit that forms a toner image on a recording medium; and
the fixing apparatus according to claim 3 that fixes the toner image to the recording medium.

14. An image forming system comprising:
an image formation unit that forms a toner image on a recording medium; and
the fixing apparatus according to claim 4 that fixes the toner image to the recording medium.

15. An image forming system comprising:
an image formation unit that forms a toner image on a recording medium; and
the fixing apparatus according to claim 5 that fixes the toner image to the recording medium.

16. An image forming system comprising:
an image formation unit that forms a toner image on a recording medium; and
the fixing apparatus according to claim 6 that fixes the toner image to the recording medium.

17. An image forming system comprising:
an image formation unit that forms a toner image on a recording medium; and
the fixing apparatus according to claim 7 that fixes the toner image to the recording medium.

18. An image forming system comprising:
an image formation unit that forms a toner image on a recording medium; and
the fixing apparatus according to claim 8 that fixes the toner image to the recording medium.

19. An image forming system comprising:
an image formation unit that forms a toner image on a recording medium; and
the fixing apparatus according to claim 9 that fixes the toner image to the recording medium.

20. An image forming system comprising:
an image formation unit that forms a toner image on a recording medium; and
the fixing apparatus according to claim 10 that fixes the toner image to the recording medium.
